(19) United States
(12) Patent Application Publication
(10) Pub. No.: US 2008/0119351 A1
(43) Pub. Date: May 22, 2008

(54) Decomposing catalyst for perfluorinated compound, carbon hydrofluoride, perchloro-carbon and carbon hydrochloride gas compounds and method of producing it

(76) Inventor: Po-Chu Liu, Taoyuan County (TW)

Correspondence Address: BACON & THOMAS, PLLC, 625 SLATERS LANE, FOURTH FLOOR, ALEXANDRIA, VA, 22314, US

(21) Appl. No.: 11/603,066

(22) Filed: Nov. 22, 2006

(51) Int. Cl. B01J 21/18; B01J 21/16; B05D 7/00

(52) U.S. Cl. 502/62; 502/80; 502/174; 502/63; 427/215

(57) ABSTRACT

A decomposing catalyst for decomposing perfluorinated compound, carbon hydrofluoride, perchloro-carbon and carbon hydrochloride gas compounds as well as a method of producing the catalyst, the catalyst contains at least high temperature durable carrier with large surface areas and effectively decomposed components; the effectively decomposed components further includes transitional metal compounds, precious metals and phosphate. The above materials are mixed, granulated, sintered, immersed in solution and dried to form the decomposing catalyst able to decompose gaseous perfluorinated compound and fluorochloro-compounds. The method particularly suits decomposing perfluorinated compound, carbon hydrofluoride, perchloro-carbon and carbon hydrochloride gases exhausted from the processes of dry etch and chemical vapor deposition (CVD) in producing semiconductors and liquid crystal panels.

### BACKGROUND OF THE INVENTION

1. Field of the Invention

The present invention relates to a decomposing catalyst for decomposing perfluorinated compound, carbon hydrofluoride, perchloro-carbon and carbon hydrochloride gas compounds as well as a method of producing the catalyst, and especially to such a decomposing catalyst and such a method particularly suiting decomposing perfluorinated compound, carbon hydrofluoride, perchloro-carbon and carbon hydrochloride gases exhausted from the processes of dry etch and chemical vapor deposition (CVD) in producing semiconductors and liquid crystal panels.

2. Description of the Prior Art

In the recent years, influence of the global green house effect on the weather of the whole world gets more and more apparent, advanced countries and environmental protection groups all pay attention to the influence generated by exhausting of various gases in which the influence of perfluorinated compound gas is most astonishing; as a comparison in quantity, the influence resulted from perfluorinated compound, carbon hydrofluoride, perfluoro-carbon and carbon hydrochloride gas is several thousands to several decades of thousands of that of carbon dioxide (CO₂). (The value of global warming potential GWP of CO₂ is set as 1).

Generating of perfluorinated compound, carbon hydrofluoride, perchloro-carbon and carbon hydrochloride gases mostly comes from the waste gases exhausted from the processes of dry etch and chemical vapor deposition (CVD) in manufacturing semiconductors and liquid crystal panels. The perfluoro-compounds mean the gas compounds containing perfluoro-carbon, nitrogen and sulfur etc., such as nitrogen trifluoride (NF₃), carbon tetrafluoride (CF₄), hexafluoro-ethane (C₂F₆), octafluoro-propane (C₃F₈), decafluoro-butane (C₄F₁₀), sulfur hexafluoride (SF₆) etc. While carbon hydrofluoride gas is the gas of hydrocarbon containing fluorine, such as hydrotrifluoro-methane (CHF₃), dihydrodifluoro-methane (CH₂F₂) and trihydrofluoro-methane (CH₃F) etc. And perchloro-carbon and carbon hydrofluoride gases are gases of hydrocarbons containing chlorine, such as carbon tetrachloride (CCl₄), dichloro-methane (CH₂Cl₂), dichloro-ethane (C₂H₄Cl₂) etc. are all waste gases processed having to be dealt with.

Methods and equipment (local scrubber) for dealing with processed waste gases presently have three kinds including the combustion type, the plasma type and the catalyst decomposition type. These three kinds of methods and equipment have their advantages and defects in practicing; the present invention makes improvement against the defects of the catalyst decomposition type, in order to make this type more meet the strategy of environmental protection nowadays.

As shown in FIG. 1 which is a schematic view showing the catalyst decomposition type method and equipment (local scrubber) for waste gas processing, wherein the decomposing catalyst in catalyst processing are placed in a heating device 10, during the process that the processed waste gas enters for heating (under the temperature of 600-1200□) from an inlet 11 of the heating device 10 and is exhausted from an outlet 12 of the heating device 10, by the action of the processed waste gas and the catalyst, the compounds of perfluorinated compound, carbon hydrofluoride, perfluoro-carbon and carbon hydrochloride can be decomposed. The gas after decomposing passes sequentially through a water cooling device 20 and a medicine adsorption device 30 and then can be exhausted to the atmosphere.

In the above stated process of catalyst processing, by virtue that before the processed waste gas enters the heating device 10, water is required to wash out the solid components (SiO₂, WO₃, Si₃N₄) and perfluoro-silicane SiF₄, thereby the processed waste gas has been rich in vapor, air and nitrogen gas when the catalyst is processed, and the gas flow is 400-1000 slm with a quite high flow rate, if the processed waste gas can not be fast decomposed by using the catalyst, the non-decomposed gas compounds of perfluorinated compound, carbon hydrofluoride, perchloro-carbon and carbon hydrochloride will exhausted to the atmosphere to create serious pollution.

The problems resided in the catalyst decomposition type method and equipment (local scrubber) for waste gas processing presently include: 1. inadequate effect of catalyst processing; 2. inadequate durability and stability of the catalyst; and 3. weak structure and small surface area of the catalyst etc. Although their safety and maintenance as well as changing of the method and equipment are excellent as compared with other types, the fetal defect of them restrains the wideness of application of them. Therefore, the present invention makes improvement against the defects of catalyst decomposing of the catalyst decomposition type method and equipment (local scrubber), in order to make this type more meet the strategy of global environmental protection in the KYOTO PROTOCOL with the requirement on reducing greenhouse gases nowadays.

### SUMMARY OF THE INVENTION

The decomposing catalyst for decomposing perfluorinated compound, carbon hydrofluoride, perchloro-carbon and carbon hydrochloride gas compounds as well as the method of producing the catalyst of the present invention were dealt with from increasing the structural strength and the surface area. In which high temperature durable ceramic material and components effectively decomposed from compounds of perfluorinated compound, carbon hydrofluoride, perfluoro-carbon and carbon hydrochloride are added with carbon powder in some suitable ratio to make granules that are shaped, and that are sintered under high temperature to obtain high temperature durable carrier with high strength and large surface areas, the carrier is made porous granular catalyst after immersing and drying.

In the above stated catalyst of the present invention, the ceramic material further includes pottery clay 40-80%, clay 5-30% and adhesive 5-30% (such as water glass, soluble silicon gum, polyvinyl alcohol PVA, resin) of the catalyst by weight; while the components effectively decomposed from fluoride further includes transitional metal compounds (such as Al₂O₃, Fe₂O₃, CaO, Y₂O₃, CeO etc.) and precious metals 5-20% as well as phosphate (such as AlPO₄, H₃PO₄, Ca₃(PO₄)₂ etc.) 10-40% of the catalyst by weight.

After FTIR test (a sample is taken at the outlet 12 of the heating device 10 shown in the above stated FIG. 1), the gas compounds of perfluorinated compound, carbon hydrofluoride, perchloro-carbon and carbon hydrochloride with the gas flow 400-1000 slm are processed under the working temperature of 600-1200□ with the catalyst of the present invention, the concentration of the compounds of perfluorinated compound, carbon hydrofluoride, perchloro-carbon and carbon hydrochloride contained in the exhausted gas after decomposing is lower than 0.1%, this meets the standard of environmental protection presently and in the future.

The present invention will be apparent after reading the detailed description of the preferred embodiment thereof in reference to the accompanying drawings.

### BRIEF DESCRIPTION OF THE DRAWINGS

FIG. 1 is a schematic view showing the conventional catalyst decomposition type method and equipment for waste gas processing;

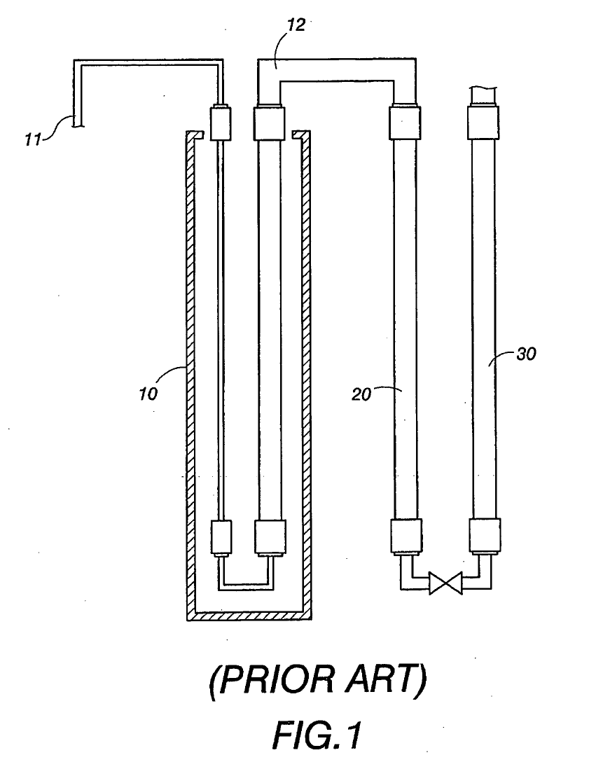

FIG. 2 is a process flow chart of a first embodiment of the method of manufacturing of the present invention;

FIG. 3 is a process flow chart of a second embodiment of the method of manufacturing of the present invention.

### DETAILED DESCRIPTION OF THE PREFERRED EMBODIMENT

The present invention is related to a decomposing catalyst for decomposing perfluorinated compound, carbon hydrofluoride, perchloro-carbon and carbon hydrochloride gas compounds as well as the method of producing the catalyst, the decomposing catalyst particularly suiting decomposing perfluorinated compound, carbon hydrofluoride, perchloro-carbon and carbon hydrochloride gases exhausted from the processes of dry etch and chemical vapor deposition (CVD) in producing semiconductors and liquid crystal panels. Wherein the perfluoro-compounds mean the gas compounds containing perfluoro-carbon, nitrogen and sulfur etc., such as nitrogen trifluoride (NF₃), carbon tetrafluoride (CF₄), hexafluoro-ethane (C₂F₆), octafluoro-propane (C₃F₈), decafluoro-butane (C₄F₁₀), sulfur hexafluoride (SF₆) etc. While carbon hydrofluoride gas is the gas of hydrocarbon containing fluorine, such as hydrotrifluoro-methane (CHF₃), dihydrodifluoro-methane (CH₂F₂) and trihydrofluoro-methane (CH₃F) etc. And perchloro-carbon and carbon hydrofluoride gases are gases of hydrocarbons containing chlorine, such as carbon tetrachloride (CCl₄), dichloro-methane (CH₂Cl₂), dichloro-ethane (C₂H₄Cl₂) etc. being all waste gases processed having to be dealt with.

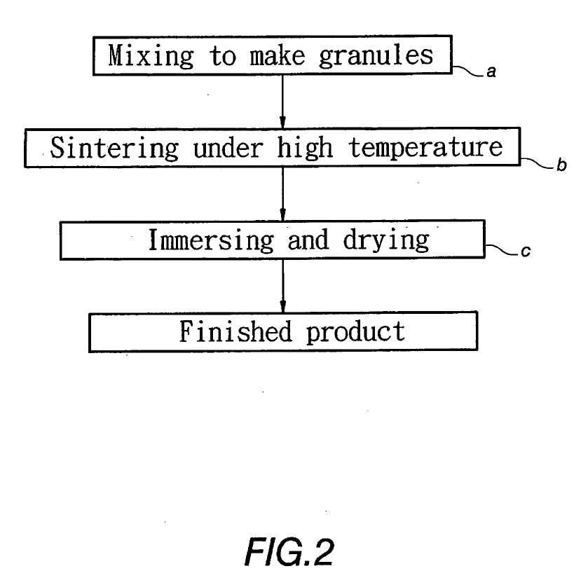

As shown in FIG. 2, the method of producing the catalyst for decomposing perfluorinated compound, carbon hydrofluoride, perchloro-carbon and carbon hydrochloride gas includes the following steps:
(a) Mixing to make granules: high temperature durable ceramic material and components effectively decomposed from compounds of perfluorinated compound, carbon hydrofluoride, perchloro-carbon and carbon hydrochloride are added with carbon powder and then are placed in a granulating machine to make them shaped granules.
(b) Sintering under high temperature: to place the granules made by mixing and granulating in a high temperature furnace to be sintered under the working temperature of 600-1200□ to form porous granular carrier.
(c) Immersing and drying: the carrier obtained after sintering is immersed in solution containing phosphate, and then is dried to form granular catalyst.

In practicing, the ceramic material in step (a) of mixing to make granules in the above stated method of decomposing catalyst and producing the catalyst further contains: pottery clay 40-80%, clay 5-30% and adhesive 5-30% of the catalyst by weight. In practicing, the adhesive at least includes water glass, soluble silicon gum, polyvinyl alcohol PVA and resin. And the amount of carbon powder is preferably 10-50% of the catalyst by weight.

In the above step (a) of mixing to make granules, the components effectively decomposed from perfluorinated compound, carbon hydrofluoride, perchloro-carbon and carbon hydrochloride mainly is composed of transitional metal compounds and precious metals 5-20% as well as phosphate 10-40% of the catalyst by weight. Wherein the transitional metal compounds and precious metals includes at least: aluminum oxide Al₂O₃, nickel oxide Ni₂O₃, ironic oxide Fe₂O₃, calcium oxide CaO, yttrium oxide Y₂O₃, cerium oxide CeO, platinum Pd, palladium Pt, rhodium Rh and calcium carbonate CaCO₃; while phosphate includes at least: aluminium phosphate AlPO₄, phosphoric acid H₃PO₄, calcium phosphate Ca₃(PO₄)₂, ammonium phosphate (NH₄)H₂PO₄. With the above catalyst components of transitional metal compounds and phosphate, the compounds of perfluorinated compound, carbon hydrofluoride, perchloro-carbon and carbon hydrochloride can be effectively decomposed.

The main object of the above step (b) of sintering under high temperature is to use the granular mixture obtained after the step (a) of mixing to make granules to be subjected to high temperature sintering to form porous structure as catalyst carrier. The nature of porosity of the granular carrier obtained after sintering can increase the contact areas of the carrier with the gas compounds of perfluorinated compound, carbon hydrofluoride, perchloro-carbon and carbon hydrochloride; when the gas compounds of perfluorinated compound, carbon hydrofluoride, perchloro-carbon and carbon hydrochloride are contacted with the granular carrier, their reacting rate can be speeded up to get an object of speeding up decomposition of the perfluorinated compound, carbon hydrofluoride, perchloro-carbon and carbon hydrochloride. While the time for sintering can be adjusted in pursuance of the working temperature and components, this can be completed in about 8-14 hours.

In the above step (c) of immersing and drying, the carrier obtained after sintering is immersed in solution containing phosphate in the amount 10-40% of the catalyst by weight, the components therein includes at least: aluminium phosphate AlPO₄, phosphoric acid H₃PO₄, calcium phosphate Ca₃(PO₄)₂ and ammonium phosphate (NH₄)H₂PO₄. While the solution stated is preferably water solution.

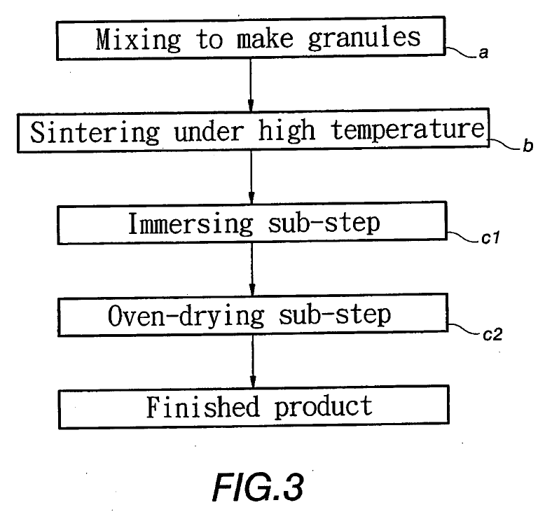

As shown in FIG. 3, the above step (c) of immersing and drying contains an immersing sub-step (c1) and an oven-drying sub-step (c2). Wherein the time for immersing is preferably 3-5 hours; in the oven-drying sub-step (c2) the carrier after the immersing sub-step (c1) can be placed in an oven for drying for 4-12 hours under a temperature from the value higher than room temperature to 140□.

The followings is an embodiment of the decomposing catalyst for decomposing perfluorinated compound, carbon hydrofluoride, perchloro-carbon and carbon hydrochloride gas compounds as well as a method of producing the catalyst, it is not for giving any limitation to the scope of the present invention.

### EXAMPLE 1

the components effectively decomposed are combinations of aluminium phosphate AlPO₄ and yttrium oxide Y₂O₃

70 grams of pottery clay is added with 20 grams clay, 10 grams aluminum oxide Al₂O₃, 30 g (5%) polyvinyl alcohol (PVA) solution, 20 g carbon powder, 10 g aluminium phosphate AlPO₄, 2 g yttrium oxide Y₂O₃ and 5 g calcium oxide CaO; and then all of them are placed in a 500 ml round-bottom flask, and are stirred with a stirring machine for 2 hours to mix them sufficiently and uniformly. After sticky solids are removed and placed in a granulating machine to form shaped granules, they are placed in a high temperature furnace to be sintered for 12 hours under the working temperature of 1200□; and after the temperature is settled down, the solids are removed to be immersed in a 10% aluminium phosphate AlPO₄ water solution for 4 hours, then are removed for air drying and again are placed in a 120□ drying oven for 6 hours for drying, then a finished product is obtained.

### EXAMPLE 2

the components effectively decomposed are combinations of phosphoric acid H₃PO₄ and cerium oxide CeO.

70 grams of pottery clay is added with 20 grams clay, 20 grams aluminum oxide Al₂O₃, 30 g (5%) polyvinyl alcohol (PVA) solution, 20 g carbon powder, 5 g cerium oxide CeO and 5 g calcium oxide CaO; and then all of them are placed in a 500 ml round-bottom flask, and are stirred with a stirring machine for 2 hours to mix them sufficiently and uniformly. After sticky solids are removed and placed in a granulating machine to form shaped granules, they are placed in a high temperature furnace to be sintered for 12 hours under the working temperature of 1200□; and after the temperature is settled down, the solids are removed to be immersed in a 20% phosphoric acid H₃PO₄ water solution for 4 hours, then are removed for air drying and again are placed in a 120□ drying oven for 12 hours for drying, then a finished product is obtained.

### EXAMPLE 3

the components effectively decomposed are combinations of calcium phosphate Ca₃(PO₄)₂ and cerium oxide CeO.

70 grams of pottery clay is added with 20 grams clay, 10 grams aluminum oxide Al₂O₃, 30 g (5%) polyvinyl alcohol (PVA) solution, 20 g carbon powder, 10 g calcium phosphate Ca₃(PO₄)₂, 2 g cerium oxide CeO and 5 g calcium oxide CaO; and then all of them are placed in a 500 ml round-bottom flask, and are stirred with a stirring machine for 2 hours to mix them sufficiently and uniformly. After sticky solids are removed and placed in a granulating machine to form shaped granules, they are placed in a high temperature furnace to be sintered for 12 hours under the working temperature of 1200□; and after the temperature is settled down, the solids are removed to be immersed in a 10% calcium phosphate Ca₃(PO₄)₂ water solution for 4 hours, then are removed for air drying and again are placed in a 120□ drying oven for 6 hours for drying, then a finished product is obtained.

### EXAMPLE 4

the components effectively decomposed are combinations of ammonium phosphate (NH₄)H₂PO₄ and cerium oxide CeO.

70 grams of pottery clay is added with 20 grams clay, 10 grams aluminum oxide Al₂O₃, 30 g (5%) polyvinyl alcohol (PVA) solution, 20 g carbon powder, 10 g ammonium phosphate (NH₄)H₂PO₄, 2 g cerium oxide CeO and 5 g calcium oxide CaO; and then all of them are placed in a 500 ml round-bottom flask, and are stirred with a stirring machine for 2 hours to mix them sufficiently and uniformly. After sticky solids are removed and placed in a granulating machine to form shaped granules, they are placed in a high temperature furnace to be sintered for 12 hours under the working temperature of 1200□; and after the temperature is settled down, the solids are removed to be immersed in a 10% ammonium phosphate (NH₄)H₂PO₄ water solution for 4 hours, then are removed for air drying and again are placed in a 120□ drying oven for 6 hours for drying, then a finished product is obtained.

### EXAMPLE 5

the components effectively decomposed are combinations of ammonium phosphate (NH₄)H₂PO₄ and yttrium oxide Y₂O₃.

70 grams of pottery clay is added with 20 grams clay, 20 grams aluminum oxide Al₂O₃, 30 g (5%) polyvinyl alcohol (PVA) solution, 20 g carbon powder, 10 g ammonium phosphate (NH₄)H₂PO₄, 2 g yttrium oxide Y₂O₃ and 5 g calcium oxide CaO; and then all of them are placed in a 500 ml round-bottom flask, and are stirred with a stirring machine for 2 hours to mix them sufficiently and uniformly. After sticky solids are removed and placed in a granulating machine to form shaped granules, they are placed in a high temperature furnace to be sintered for 12 hours under the working temperature of 1200□; and after the temperature is settled down, the solids are removed to be immersed in a 30% ammonium phosphate (NH₄)H₂PO₄ water solution for 4 hours, then are removed for air drying and again are placed in a 120□ drying oven for 6 hours for drying, then a finished product is obtained.

### EXAMPLE 6

the components effectively decomposed are combinations of phosphoric acid H₃PO₄ and yttrium oxide Y₂O₃.

70 grams of pottery clay is added with 20 grams clay, 20 grams aluminum oxide Al₂O₃, 30 g (5%) polyvinyl alcohol (PVA) solution, 20 g carbon powder, 10 g aluminium phosphate AlPO₄, 2 g yttrium oxide Y₂O₃ and 5 g calcium oxide CaO; and then all of them are placed in a 500 ml round-bottom flask, and are stirred with a stirring machine for 2 hours to mix them sufficiently and uniformly. After sticky solids are removed and placed in a granulating machine to form shaped granules, they are placed in a high temperature furnace to be sintered for 12 hours under the working temperature of 1200□; and after the temperature is settled down, the solids are removed to be immersed in a 20% phosphoric acid H₃PO₄ water solution for 4 hours, then are removed for air drying and again are placed in a 120□ drying oven for 12 hours for drying, then a finished product is obtained.

The embodiments given are only for illustrating the technical content of the present invention, and not for giving any limitation to the scope of the present invention. It will be apparent to those skilled in this art that various equivalent modifications or changes without departing from the spirit of this invention shall also fall within the scope of the appended claims.

1. A method of producing a decomposing catalyst for decomposing perfluorinated compound, carbon hydrofluoride, perchloro-carbon and carbon hydrochloride gas compounds, said method includes following steps:
(a) mixing high temperature durable ceramic material and components effectively decomposed from said compounds of perfluorinated compound, carbon hydrofluoride, perchloro-carbon and carbon hydrochloride with carbon powder to make granules;
(b) sintering said granules made by said mixing and granulating under a working temperature of 600-1200□ to form porous granular carrier;
(c) immersing said carrier obtained after said sintering in solution containing phosphate, and then drying them to form granular catalyst.

2. The method of producing a decomposing catalyst for decomposing perfluorinated compound, carbon hydrofluoride, perchloro-carbon and carbon hydrochloride gas compounds as in claim 1, wherein said ceramic material in said step (a) includes: pottery clay, clay and adhesive.

3. The method of producing a decomposing catalyst for decomposing perfluorinated compound, carbon hydrofluoride, perchloro-carbon and carbon hydrochloride gas compounds as in claim 2, wherein amount of said pottery clay is 40-80%, said clay is 5-30% and said adhesive is 5-30% of said catalyst by weight.

4. The method of producing a decomposing catalyst for decomposing perfluorinated compound, carbon hydrofluoride, perchloro-carbon and carbon hydrochloride gas compounds as in claim 3, wherein said adhesive at least includes water glass, soluble silicon gum, polyvinyl alcohol PVA and resin.

5. The method of producing a decomposing catalyst for decomposing perfluorinated compound, carbon hydrofluoride, perchloro-carbon and carbon hydrochloride gas compounds as in claim 1, wherein said components effectively decomposed from said compounds of perfluorinated compound, carbon hydrofluoride, perchloro-carbon and carbon hydrochloride in said step (a) further contain transitional metal compounds and precious metals 5-20% as well as phosphate 10-40% of said catalyst by weight.

6. The method of producing a decomposing catalyst for decomposing perfluorinated compound, carbon hydrofluoride, perchloro-carbon and carbon hydrochloride gas compounds as in claim 5, wherein said transitional metal compounds and precious metals at least include: aluminum oxide Al₂O₃, nickel oxide Ni₂O₃, ironic oxide Fe₂O₃, calcium oxide CaO, yttrium oxide Y₂O₃, cerium oxide CeO, platinum Pd, palladium Pt, rhodium Rh and calcium carbonate CaCO₃.

7. The method of producing a decomposing catalyst for decomposing perfluorinated compound, carbon hydrofluoride, perchloro-carbon and carbon hydrochloride gas compounds as in claim 5, wherein said phosphate includes at least: aluminium phosphate AlPO₄, phosphoric acid H₃PO₄, calcium phosphate Ca₃(PO₄)₂ and ammonium phosphate (NH₄)H₂PO₄.

8. The method of producing a decomposing catalyst for decomposing perfluorinated compound, carbon hydrofluoride, perchloro-carbon and carbon hydrochloride gas compounds as in claim 1, wherein amount of said carbon powder is 10-50% of said catalyst by weight.

9. The method of producing a decomposing catalyst for decomposing perfluorinated compound, carbon hydrofluoride, perchloro-carbon and carbon hydrochloride gas compounds as in claim 1, wherein time for said sintering is 8-14 hours.

10. The method of producing a decomposing catalyst for decomposing perfluorinated compound, carbon hydrofluoride, perchloro-carbon and carbon hydrochloride gas compounds as in claim 1, wherein time for said immersing in said step (c) is 3-5 hours.

11. The method of producing a decomposing catalyst for decomposing perfluorinated compound, carbon hydrofluoride, perchloro-carbon and carbon hydrochloride gas compounds as in claim 1, wherein said drying in said step (c) is to air dry said carrier after said immersing in a room temperature.

12. The method of producing a decomposing catalyst for decomposing perfluorinated compound, carbon hydrofluoride, perchloro-carbon and carbon hydrochloride gas compounds as in claim 1, wherein said drying in said step (c) is to place said carrier after said immersing in an oven for drying for 4-12 hours under a temperature from a value higher than room temperature to 140□.

13. The method of producing a decomposing catalyst for decomposing perfluorinated compound, carbon hydrofluoride, perchloro-carbon and carbon hydrochloride gas compounds as in claim 1, wherein amount of said phosphate in said step (c) is 10-40% of said catalyst by weight.

14. The method of producing a decomposing catalyst for decomposing perfluorinated compound, carbon hydrofluoride, perchloro-carbon and carbon hydrochloride gas compounds as in claim 1, wherein said phosphate includes at least: aluminium phosphate AlPO₄, phosphoric acid H₃PO₄, calcium phosphate Ca₃(PO₄)₂, ammonium phosphate (NH₄)H₂PO₄.

15. A decomposing catalyst for decomposing perfluorinated compound, carbon hydrofluoride, perchloro-carbon and carbon hydrochloride gas compounds, said decomposing catalyst are porous granular, and are obtained by sintering high temperature durable ceramic material and components effectively decomposed from compounds of perfluorinated compound, carbon hydrofluoride, perfluoro-carbon and carbon hydrochloride.

16. The decomposing catalyst for decomposing perfluorinated compound, carbon hydrofluoride, perchloro-carbon and carbon hydrochloride gas compounds as in claim 15, wherein amount of said ceramic material is 40-80%, said clay is 5-30% and said adhesive is 5-30% of said catalyst by weight.

17. The decomposing catalyst for decomposing perfluorinated compound, carbon hydrofluoride, perchloro-carbon and carbon hydrochloride gas compounds as in claim 15, wherein said components effectively decomposed from said compounds of perfluorinated compound, carbon hydrofluoride, perchloro-carbon and carbon hydrochloride further contain transitional metal compounds and precious metals 5-20% as well as phosphate 10-40% of said catalyst by weight.

18. The decomposing catalyst for decomposing perfluorinated compound, carbon hydrofluoride, perchloro-carbon and carbon hydrochloride gas compounds as in claim 16, wherein said adhesive at least includes water glass, soluble silicon gum, polyvinyl alcohol PVA and resin.

19. The decomposing catalyst for decomposing perfluorinated compound, carbon hydrofluoride, perchloro-carbon and carbon hydrochloride gas compounds as in claim 17, wherein said transitional metal compounds and precious metal at least include: aluminum oxide Al₂O₃, nickel oxide Ni₂O₃, ironic oxide Fe₂O₃, calcium oxide CaO, yttrium oxide Y₂O₃, cerium oxide CeO, platinum Pd, palladium Pt, rhodium Rh and calcium carbonate CaCO₃.

20. The decomposing catalyst for decomposing perfluorinated compound, carbon hydrofluoride, perchloro-carbon and carbon hydrochloride gas compounds as in claim 17, wherein said phosphate includes at least: aluminium phosphate AlPO₄, phosphoric acid H₃PO₄, calcium phosphate Ca₃(PO₄)₂ and ammonium phosphate (NH₄)H₂PO₄.
